(19) United States
(12) Patent Application Publication
(10) Pub. No.: US 2022/0099180 A1
(43) Pub. Date: Mar. 31, 2022

(54) VEHICLE TRANSMISSION

(71) Applicant: HONDA MOTOR CO., LTD., Tokyo (JP)

(72) Inventors: Eiji Kittaka, Tokyo (JP); Takashi Kudo, Tokyo (JP)

(21) Appl. No.: 17/482,473

(22) Filed: Sep. 23, 2021

(30) Foreign Application Priority Data
Sep. 30, 2020 (JP) 2020-164438

(51) Int. Cl. F16H 63/18; F16H 61/32

(52) U.S. Cl. CPC F16H 63/18; B62M 11/04; F16H 61/32

(57) ABSTRACT

An ECU rotates a shift drum in a first direction by driving of an actuator, changes an axial position of an engaging protrusion of a shift fork from a first axial position corresponding to a first gear level before gear shifting to a second axial position corresponding to a second gear level after gear shifting, rotates the shift drum in a second direction opposite to the first direction by a prescribed angle within a range in which the second gear level is maintained by driving of the actuator, and returns the axial position of the engaging protrusion of the shift fork to a side closer to the first axial position than the second axial position by a prescribed amount.

### CROSS-REFERENCE TO RELATED APPLICATION

Priority is claimed on Japanese Patent Application No. 2020-164438, filed Sep. 30, 2020, the content of which is incorporated herein by reference.

### BACKGROUND OF THE INVENTION

### Field of the Invention

The present invention relates to a vehicle transmission.

### Description of Related Art

In the related art, in a vehicle transmission, a technology in which a shift drum is pivoted by an actuator and a shift change of a gear change device can be performed by pivoting of the shift drum is known (for example, see Japanese Unexamined Patent Application, First Publication No. 2011-208766).

The above mentioned related art has the same configuration as a manual gear change device. That is, the actuator drives a shift spindle parallel to a shift drum and having separate axis, and pivots a shift arm fixed to the shift spindle. A ratchet mechanism is provided between the shift arm and the shift drum. In the ratchet mechanism, the shift arm pivots the shift drum by a prescribed angle by performing positive/reverse rotation of the prescribed angle. These shift spindle, shift arm and ratchet mechanism are the same as the configuration of the manual gear change device.

### SUMMARY OF THE INVENTION

Incidentally, in an automatic gear change device in which a shift operation is performed by driving of an actuator, in order to achieve improvement of a shifting speed or shifting accuracy and reduction in system costs, the following configurations are being considered. That is, employment of a system in which an actuator directly drives a shift drum with no intervention of a configuration of the manual gear change device (a shift drum direct drive system) is being considered. According to the system, it is expected that both higher sports performance and easy drive will be compatible.

Upon gear shifting of the gear change device using the shift drum, a shift fork is moved in an axial direction by driving of the shift drum, and a shifter gear (a shifter member) of the gear change device is moved in the axial direction to change a gear level. The shift fork is engaged with a guide groove formed in an outer circumference of the shift drum and is moved in the axial direction according to a pattern of the guide groove. The shifter gear is fitted to a stationary gear that is immovable in the axial direction at a moving destination in a concavo-convex fixing manner. One of the shifter gear and the stationary gear includes a dog as a convex portion protruding in the axial direction, and the other of the shifter gear and the stationary gear includes a slot as a concave section into and from which the dog can be inserted and separated in the axial direction.

With respect to such a gear change device, in the above mentioned system in which the shift drum is directly driven by the actuator, the following problems can be considered. That is, when relative torques are applied to the dog and the slot, since frictional forces are generated in their torque-receiving surfaces, it is conceivable that movement of the shifter gear in the axial direction may be stopped before a termination position. Even when movement of the shifter gear in the axial direction is not completely terminated, if the unreached distance in the movement is a small amount, a fitting allowance (engagement allowance) required for torque transmission between the shifter gear and the stationary gear is secured. However, since the actuator continues to operate until a pivoting angle of the shift drum reaches a target value, as a result, it is conceivable that a heavy load continues to be applied to the shift fork. In addition, when a dedicated sensor or control is provided to perform control of restricting driving of the actuator, a configuration of the entire apparatus becomes complicated.

An aspect of the present invention is directed to providing a vehicle transmission capable of minimizing continuous application of a heavy load to a shift fork even when there is a catch in movement of a shifter member in an axial direction, while a configuration of the entire apparatus is simplified.

(1) A vehicle transmission that is an aspect of the present invention includes a gear change device configured to support a shifting gear group having a plurality of gear levels on a gear change device shaft and configured to move a shifter member in an axial direction of the gear change device shaft for switching the gear levels; a shift fork configured to engage a tip portion of the shift fork with the shifter member and move the shifter member in the axial direction; a shift drum formed in a cylindrical shape having a central axis parallel to the axial direction, having a guide groove formed in an outer circumferential section of the shift drum and guides movement of the shift fork in the axial direction, configured to engage an engaging section provided on a base end portion of the shift fork with the guide groove, configured to move the engaging section along the guide groove by being rotated around the central axis, and configured to change an axial position of the shift fork for switching the gear levels of the gear change device; and an actuator configured to pivot the shift drum, wherein the transmission changes the axial position of the engaging section of the shift fork from a first axial position corresponding to a first gear level before gear shifting to a second axial position corresponding to a second gear level after gear shifting, and within a range in which the second gear level is maintained, the shift drum is rotated and the axial position of the engaging section of the shift fork is returned to a side closer to the first axial position than the second axial position by a prescribed amount.

According to the configuration of the aspect of the above-mentioned (1), after the gear level of the gear change device is switched from the first gear level to the second gear level, the base end side of the shift fork is returned toward the first axial position before gear shifting by the prescribed amount through rotation of the shift drum while the second gear level is maintained. For this reason, an influence on frictional resistance generated in the concavo-convex fitting section between the shifter member and the counter member that is a moving destination thereof is minimized That is, even when movement of the tip side of the shifter member in the axial direction stops before the target position after gear shifting, the shift fork is prevented from being continuously heavily loaded. When the insufficient amount in the movement of the shifter member in the axial direction is small, an effective fitting allowance (an engagement allowance) required for torque transmission between the shifter member and the moving destination member is secured. In addition, the shift drum can also be rotated to the extent of a target angle according to inclination or bending of the shift fork. Meanwhile, the shift fork is continuously heavily loaded and damage such as uneven wear or the like is likely to occur in the shift fork while the inclination or deformation is generated in the shift fork.

On the other hand, according to the configuration of the above-mentioned (1), the following effects are exhibited while using a system in which the shift drum is directly driven by the actuator. Even when a catch occurs in movement of the shifter member in the axial direction, it is possible to prevent an excessive load from being input to the shift fork.

For example, while such effects can be exhibited by detecting a load input state or the like of the shift fork and also controlling driving of the actuator, the configuration of the entire apparatus may be complicated. Accordingly, according to the configuration of the aspect of the above-mentioned (1), even when a catch occurs in movement of the shifter member in the axial direction while the configuration of the entire apparatus is simplified, it is possible to prevent the shift fork from being continuously heavily loaded.

(2) In the aspect of the above-mentioned (1), a control part configured to control driving of the actuator may be provided, the control part may rotate the shift drum in a first direction by driving of the actuator and change the axial position of the engaging section of the shift fork from a first axial position corresponding to a first gear level before gear shifting to a second axial position corresponding to a second gear level after gear shifting, and within a range in which the second gear level is maintained by driving of the actuator, the control part may rotate the shift drum in a second direction opposite to the first direction by a prescribed angle and return the axial position of the engaging section of the shift fork to a side closer to the first axial position than the second axial position by a prescribed amount.

According to the configuration of the aspect of the above-mentioned (2), after the actuator is positively rotated to switch the gear level of the gear change device, the actuator is reversed by the prescribed angle while the second gear level is maintained. Accordingly, the base end side of the shift fork is returned toward the first axial position before gear shifting by the prescribed amount. For this reason, an influence on frictional resistance generated in the concavo-convex fitting section between the shifter member and the counter member that is the moving destination thereof is minimized.

Accordingly, the following effects are exhibited while using the system in which the shift drum is directly driven by the actuator. Even when a catch occurs in movement of the shifter member in the axial direction, it is possible to prevent an excessive load from being continuously input to the shift fork.

(3) In the aspect of the above-mentioned (1), the guide groove may include: a changing part configured to change the axial position of the engaging section of the shift fork from a first axial position corresponding to a first gear level before gear shifting to a second axial position corresponding to a second gear level after gear shifting by rotation of the shift drum; and a returning part continuous with a side of the changing part upstream from the shift drum in a rotation direction and configured to change the axial position of the engaging section of the shift fork to a side closer to the first axial position than the second axial position by a prescribed amount within a range in which the second gear level is maintained.

According to the configuration of the aspect of the above-mentioned (3), according to a pattern of the cam groove of the shift drum, the base end side of the shift fork moved to the second axial position after gear shifting is returned toward the first axial position before gear shifting by the prescribed amount while the second gear level is maintained. That is, the base end side of the shift fork moved to the second axial position by the changing part is returned toward the first axial position by the returning part by the prescribed amount. For this reason, an influence on frictional resistance generated in the concavo-convex fitting section between the shifter member and the counter member that is the moving destination thereof is minimized.

Accordingly, for example, in the configuration in which the shift drum is directly driven by the actuator, even when a catch occurs in movement of the shifter member in the axial direction, it is possible to prevent an excessive load from being continuously input to the shift fork.

(4) In the aspect of the above-mentioned (2), a prescribed angle by which the actuator returns rotation of the shift drum may be equal to or smaller than 5 degrees.

According to the configuration of the aspect of the above-mentioned (4), for example, even when the number of gear levels of the gear change device is generally six speeds, a pivoting angle of the shift drum for each speed is 50 to 60 degrees. It is possible to prevent the shift fork from being excessively moved to a returning side and secure the engagement allowance between the shifter member and the moving destination member by minimizing the returning groove of the shift drum to 10% or less therein.

(5) In the aspect of the above-mentioned (3), a prescribed amount by which the returning part returns the shift fork may be equal to or smaller than 10% of the movement amount from the first axial position to the second axial position.

According to the configuration of the aspect of the above-mentioned (5), it is possible to prevent the shift fork from being excessively moved to the returning side and secure the engagement allowance between the shifter member and the moving destination member by minimizing the returning amount of the shift fork to 10% or less of the entire movement amount of the shift fork.

(6) In the aspect of the above-mentioned (2) or (4), the actuator may include a motor configured to generate a rotating driving force, a central axis of the shift drum and a driving axis of the motor may be parallel to each other, and a transmission mechanism configured to transmit a driving force of the motor to the shift drum may be provided at one end side of the shift drum and the motor in the axial direction.

According to the configuration of the aspect of the above-mentioned (6), since the shift drum and the motor are disposed at the same side as the transmission mechanism in the axial direction, it is possible to dispose the change mechanism including the shift drum and the actuator including the motor in a compact combination.

(7) In the aspect of the above-mentioned (6), a rotating angle sensor configured to detect a rotating angle of the shift drum may be provided at the other end side of the shift drum in the axial direction.

According to the configuration of the aspect of the above-mentioned (7), since the transmission mechanism and the rotating angle sensor are arranged and disposed on both sides of the shift drum in the axial direction, a degree of disposition freedom of parts can be increased, and surroundings of the shift drum can be configured in a compact form.

According to the aspect of the present invention, it is possible to provide a vehicle transmission capable of minimizing continuous application of a heavy load to a shift fork even when there is a catch in movement of a shifter member in an axial direction, while a configuration of the entire apparatus is simplified.

### BRIEF DESCRIPTION OF THE DRAWINGS

FIG. 1 is a deployment cross-sectional view of a major shaft of an engine in an axial direction according to a first embodiment of the present invention.

FIG. 2 is an enlarged view of a clutch and a transmission in FIG. 1.

FIG. 3 is a cross-sectional view of a change mechanism and a driving mechanism of the engine in the axial direction.

FIG. 4A is a view for explaining an operation of a shift fork of the change mechanism.

FIG. 4B is a view for explaining an operation of the shift fork of the change mechanism.

FIG. 4C is a view for explaining an operation of the shift fork of the change mechanism.

FIG. 5A is a view for explaining a returning operation of the shift fork.

FIG. 5B is a view for explaining a returning operation of the shift fork.

FIG. 6 is a view for explaining a deployment view of a guide groove of a shift drum of the change mechanism.

FIG. 7 is a flowchart showing processing of fork returning control of the engine.

FIG. 8 is a view for explaining a deployment view of a guide groove of a shift drum of a change mechanism according to a second embodiment.

FIG. 9 is an enlarged view of a portion IX of the guide groove of FIG. 8.

### DETAILED DESCRIPTION OF THE INVENTION

Hereinafter, embodiments of the present invention will be described with reference to the accompanying drawings. Further, directions of forward, rearward, leftward, rightward, and so on in the following description are the same as directions in a vehicle described below unless the context clearly indicates otherwise. In addition, in appropriate places in the drawings used in the following description, an arrow FR indicates a forward direction with respect to a vehicle, an arrow LH indicates a leftward direction with respect to the vehicle, an arrow UP indicates an upward direction with respect to the vehicle, and a line CL indicates a lateral center of a vehicle body.

### First Embodiment

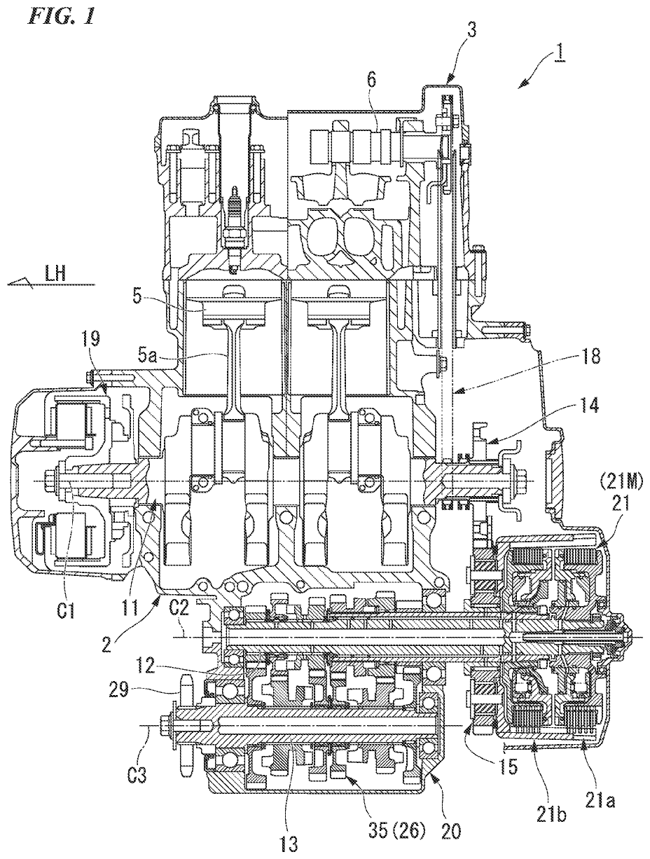

As shown in FIG. 1, a vehicle transmission according to an embodiment is applied to an engine 1 that is a prime mover for a saddle riding vehicle such as a motorcycle or the like. The engine 1 is a multiple-cylinder engine in which a rotating central axis C1 of a crankshaft 11 is provided in a vehicle width direction (a leftward/rightward direction). Hereinafter, the rotating central axis C1 of the crankshaft 11 is also referred to as “a crank axis.”

Cylinders 3 protrude from a crank case 2, and pistons 5 corresponding to the cylinders are reciprocally fitted into the cylinders 3. The pistons 5 are connected to the crankshaft 11 via connecting rods 5a. Reciprocal movement of the pistons 5 is converted into rotational movement of the crankshaft 11 via the connecting rods 5a. In the drawings, reference sign 6 indicates a cam shaft of a dynamic valve mechanism provided in a cylinder head, reference sign 18 indicates a transmission mechanism configured to connect the crankshaft 11 and the cam shaft, and reference sign 19 indicates a generator disposed coaxially with a left end portion of the crankshaft 11.

The engine 1 is a structure with which a gear change device portion is provided integrally. A rear section of the crank case 2 configures a transmission case 20 configured to accommodate a clutch, a gear change device, and the like.

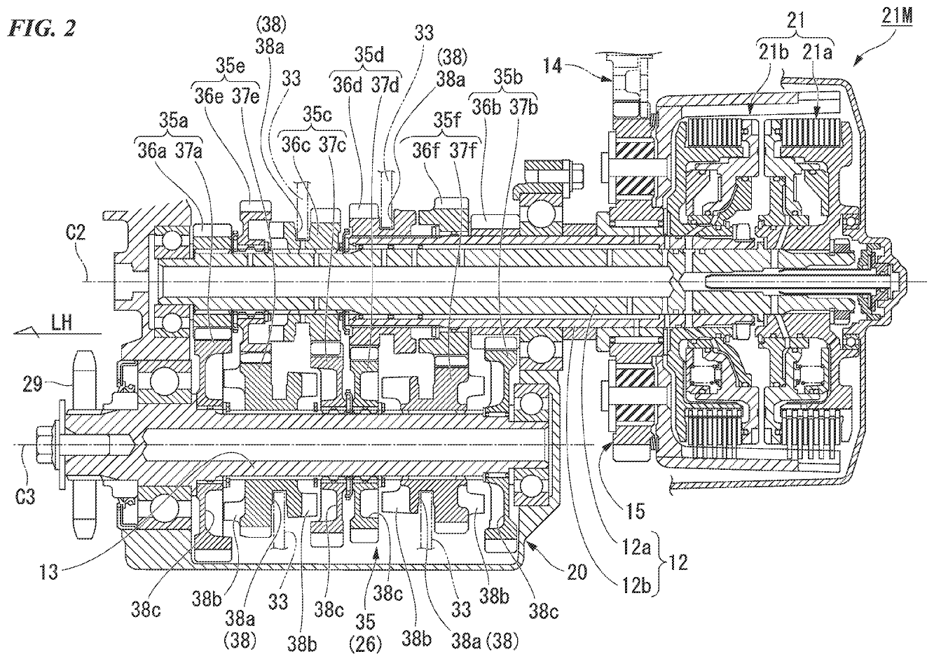

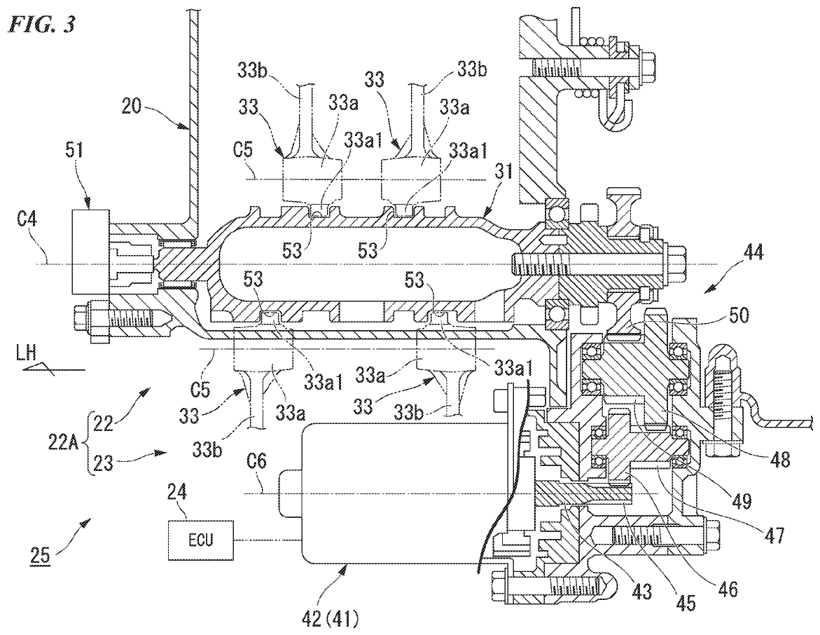

Referring also to FIG. 2 and FIG. 3, a twin clutch type gear change device 21M and a change mechanism 22 are accommodated in the transmission case 20. The twin clutch type gear change device 21M is configured by combining a twin clutch 21 and a transmission 26.

In the embodiment, the twin clutch type gear change device 21M, a gear shifting device 22A including the change mechanism 22 and a driving mechanism 23, and an electronic control unit (hereinafter referred to as an ECU) 24 configured to control actuation of the twin clutch type gear change device 21M and the gear shifting device 22A are provided to configure a gear shifting control device (a vehicle transmission) 25.

A main shaft 12 and a counter shaft 13 are disposed behind the crankshaft 11 to be arranged back and forth. The main shaft 12 and the counter shaft 13 constitute the transmission 26 together with a shifting gear group 35.

The main shaft 12 has a rotating central axis C2 parallel to the crank axis C1. The counter shaft 13 has a rotating central axis C3 parallel to the crank axis C1. Hereinafter, the rotating central axis C2 of the main shaft 12 is referred to as “a main axis,” and the rotating central axis C3 of the counter shaft 13 is referred to as “a counter axis.” In addition, an axial direction of each of the shafts 11, 12 and 13 is simply referred to as “an axial direction.”

The change mechanism 22 is disposed in the vicinity of the transmission 26.

The change mechanism 22 includes a shift drum 31 and a shift fork 33.

The shift drum 31 is disposed parallel to the main shaft 12 and the counter shaft 13. In the drawings, line C4 indicates a central axis (a drum axis) of the shift drum 31. Both end portions of the shift drum 31 are rotatably supported by the transmission case 20. A plurality of guide grooves 53 are formed in an outer circumference of the shift drum 31.

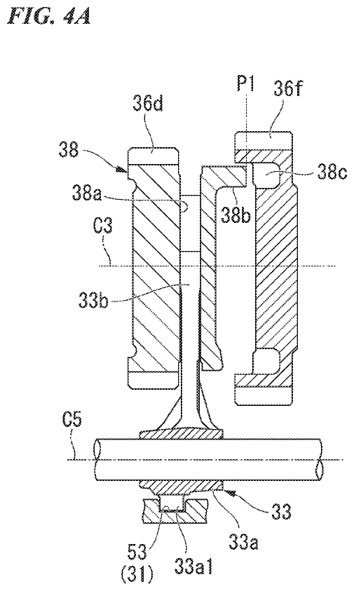

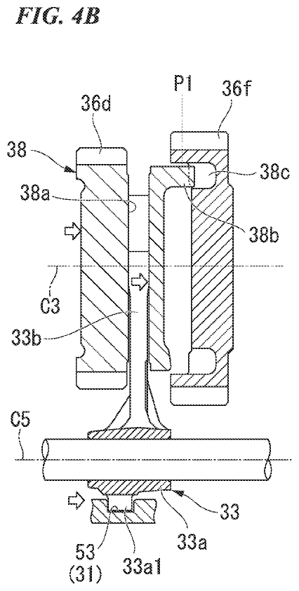

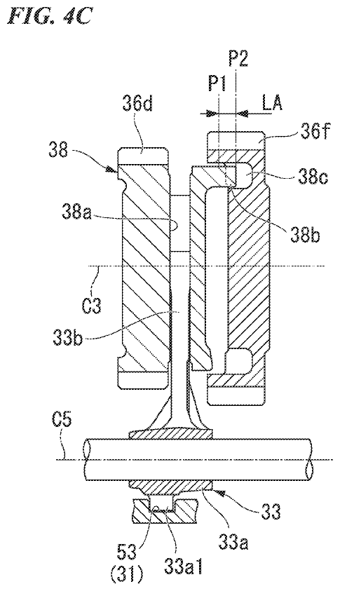

The plurality of shift forks 33 are provided. For example, pairs of the shift forks 33 are provided on each of the side of the main shaft 12 and the side of the counter shaft 13. The shift forks 33 are movably supported by fork shafts 32 (see FIG. 4A, FIG. 4B and FIG. 4C) parallel to the main shaft 12 and the counter shaft 13 in the axial direction. In the drawings, line C5 indicates a central axis of the fork shafts 32. The pair of fork shafts 32 are provided to correspond to the side of the main shaft 12 and the side of the counter shaft 13. Each of the shift forks 33 includes a cylindrical base end portion 33a inserted through one of the fork shafts 32. Engaging protrusions (engaging sections) 33a1 engaging with the corresponding guide grooves 53 in the shift drum 31 are formed in the base end portion 33a.

Tip portions 33b of the shift forks 33 are engaged with annular grooves 38a of a slide gear (a shifter member 38) (to be described below) of the transmission 26 on the side closer to the main shaft 12 and the side closer to the counter shaft 13, respectively.

The shift forks 33 are moved in the axial direction along a pattern of each of the guide grooves 53 by rotation of the shift drum 31, and the slide gear is moved in the axial direction. Accordingly, a shifting gear pair used for power transmission between the main shaft 12 and the counter shaft 13 is switched, and gear shifting (switching of a gear level) of the transmission 26 is performed.

Referring to FIG. 3, the driving mechanism 23 is connected to the change mechanism 22. The driving mechanism 23 includes an actuator 41 including an electric motor 42, and a transmission mechanism 44 configured to transmit power of the actuator 41 to the shift drum 31.

The electric motor 42 is, for example, a DC motor, and an axial direction thereof is disposed parallel to an axial direction of the shift drum 31 or the like. The electric motor 42 is provided such that a driving shaft 43 protrudes rightward. In the drawings, line C6 indicates a central axis (a driving axis) of the electric motor 42.

The transmission mechanism 44 reduces rotating power output from the electric motor 42 and transmits the reduced power to the shift drum 31. The transmission mechanism 44 includes a driving gear 45 provided on the driving shaft 43 of the electric motor 42, a first idling gear 46 meshes with the driving gear 45, a second idling gear 47 rotates with the first idling gear 46, a third idling gear 48 meshes with the second idling gear 47, a fourth idling gear 49 rotates with the third idling gear 48, and a driven gear 50 meshes with the fourth idling gear 49. The first and second idling gears 46 and 47 are formed integrally, and rotatably supported by a gear case. The third and fourth idling gears 48 and 49 are formed integrally, and rotatably supported by the gear case. The driven gear 50 is disposed coaxially with the shift drum 31, and integrally rotatably connected to the shift drum 31.

With this configuration, the actuator 41 and the shift drum 31 are normally linkable to each other via the transmission mechanism 44. Accordingly, a system configured to directly drive the shift drum 31 is constituted by the actuator 41.

The actuator 41 and the shift drum 31 have axial positions that overlap each other. The transmission mechanism 44 is provided at one end side (a left end side) of the actuator 41 and the shift drum 31 in the axial direction. Since the shift drum 31 and the actuator 41 are disposed at the same side with respect to the transmission mechanism 44 in the axial direction, the transmission mechanism 44, the shift drum 31 and the actuator 41 can be arranged in a compact combination.

A rotating angle sensor 51 configured to detect a rotating angle of the shift drum 31 is provided on the other end side (a right end side) of the shift drum 31 in the axial direction. Since the rotating angle sensor 51 is disposed at a side opposite to the transmission mechanism 44, the rotating angle sensor 51 and the transmission mechanism 44 are disposed not to interfere with each other, and a degree of disposition freedom of parts is increased.

Referring to FIG. 1 and FIG. 2, a primary drive gear 14 is provided coaxially with and rotated integrally with a right side portion of the crankshaft 11. The primary drive gear 14 meshes with a primary driven gear 15 supported coaxially with a right side portion of the main shaft 12. The primary driven gear 15 is adjacent to an outer clutch of the twin clutch 21 in a direction of the main axis C2.

Rotating power of the crankshaft 11 is reduced by the primary drive gear 14 and the primary driven gear 15 and input to the twin clutch 21. After that, the rotating driving force is input to the transmission 26 and is reduced according to a gear level, and then, is transmitted to a driving wheel via a drive sprocket 29 or the like from a left side of a rear section of the crank case 2.

The transmission 26 has the main shaft 12, the counter shaft 13, and the shifting gear group 35. The main shaft 12 and the counter shaft 13 are rotatably supported by the transmission case 20 at both of left and right sides thereof. The shifting gear group 35 is supported so as to cross each of the main shaft 12 and the counter shaft 13. Rotating power of the crankshaft 11 is transmitted to the counter shaft 13 from the main shaft 12 via an arbitrary gear pair of the shifting gear group 35. Rotating power transmitted to the counter shaft 13 is transmitted to a driving wheel via, for example, a chain type transmission mechanism. The drive sprocket 29 of the chain type transmission mechanism is integrally rotatably attached to a left end portion of the counter shaft 13 protruding toward a left side of a rear section of the crank case 2.

The shifting gear group 35 has gears corresponding to a number of gear levels supported by the main shaft 12 and the counter shaft 13. The transmission 26 is a normally meshed type in which the corresponding gear pairs in the shifting gear group 35 are always meshed with each other between the main shaft 12 and the counter shaft 13. Each of the gears supported by the main shaft 12 and the counter shaft 13 are classified into free gears rotatable with respect to the corresponding shafts and slide gears (the shifter member 38) spline-meshed with the corresponding shafts. Dogs 38b protruding in the axial direction are provided on one of the free gears and the slide gears. Slots 38c recessed in the axial direction to be engaged with the dogs 38b are provided on the other one of the free gears and the slide gears. A shifting gear pair used for power transmission can be selectively switched according to an actuation of the change mechanism 22.

The dogs 38b and the slots 38c engaged with or separated from each other are engaged with each other integrally rotatably by approaching in the axial direction, and release the engagement by being separated from each other in the axial direction. Depending on which of the dogs 38b and the slots 38c are engaged with or separated from each other, the gear pair used for power transmission between the main shaft 12 and the counter shaft 13 is switched, and thus, the gear level of the transmission 26 is switched. A state in which engagements of all the dogs 38b and the slots 38c are released (a state shown in FIG. 2) is a neutral state in which power transmission between the main shaft 12 and the counter shaft 13 are impossible.

An operation of the engine 1 is possible by an automatic mode in which operations of both of the twin clutch 21 and the transmission 26 are automatically performed. In addition, in the engine 1, only a gear shifting operation of the transmission 26 (an operation of a shifting operator) is performed by a driver, and a disconnection operation of the twin clutch 21 can be performed in a semi-automatic mode that is automatically performed by electric control according to the shifting operation.

The main shaft 12 is formed in a dual structure having an inner shaft 12a and an outer shaft 12b. In the main shaft 12, a right side portion of the inner shaft 12a laterally crossing the transmission case 20 is inserted through the outer shaft 12b. A right end portion of the inner shaft 12a protrudes rightward from a right end portion of the outer shaft 12b. A left side portion of the inner shaft 12a protrudes leftward from a left end portion of the outer shaft 12b.

Driving gears 36a to 36f corresponding to six speeds in the shifting gear group 35 are arranged and disposed on outer circumferences of the inner outer shafts 12a and 12b. The driving gears 36b, 36d and 36f corresponding to an even number of gear levels (a second speed, a fourth speed, and a sixth speed) in the shifting gear group 35 are supported by the outer shaft 12b from the left side in the order of the fourth speed, the sixth speed and the second speed. The driving gears 36a, 36c and 36e corresponding to an odd number of gear levels (a first speed, third speeds, and a fifth speeds) in the shifting gear group 35 is supported by the inner shaft 12a from the left side in the order of the first speed, the fifth speed, and the third speed.

Driven gears 37a to 37f corresponding to six speeds in the shifting gear group 35 are arranged and disposed on an outer circumference of the counter shaft 13. The driving gears 36a to 36f and the driven gears 37a to 37f are meshed with each other at each of the gear levels, and constitute shifting gear pairs 35a to 35f corresponding to the gear levels, respectively. In the shifting gear pairs 35a to 35f, a reduction gear ratio is reduced (becomes a high speed gear) in the order of the first speed to the sixth speed.

The twin clutch 21 has a first clutch 21a and a second clutch 21b. The first clutch 21a and the second clutch 21b are hydraulic disk clutches disposed coaxially adjacent to each other. The first clutch 21a is disposed on the right side (an outer side in the vehicle width direction), and the second clutch 21b is disposed on the left side (an inner side in the vehicle width direction). A right end portion of the inner shaft 12a is coaxially connected to the first clutch 21a. A right end portion of the outer shaft 12b is coaxially connected to the second clutch 21b.

Each of the clutches 21a and 21b is a wet multiple-disk clutch, and has a plurality of clutch plates overlapping each other in the axial direction. A hydraulic pressure for actuation is supplied to the clutches 21a and 21b from a hydraulic pressure supply device (not shown). The clutches 21a and 21b can be individually connected and disconnected according to existence of supply of a hydraulic pressure from a hydraulic pressure supply device.

By making one of the clutches 21a and 21b in a connected state and the other in a disconnected state, and thus, the transmission 26 performs power transmission using any shifting gear pair connected to one of the inner outer shafts 12a and 12b. Here, a shifting gear pair corresponding to the next shift position is previously selected from the shifting gear pair connected to the other of the inner outer shafts 12a and 12b. From this state, by making one of the clutches 21a and 21b in a disconnected state and the other in a connected state, and thus, the transmission 26 is switched to a power transmission state using the previously selected shifting gear pair. That is, the gear shifting of the transmission 26 is performed. Accordingly, shift-up or shift-down of the transmission 26 is performed.

When a hydraulic pressure is supplied to the first clutch 21a, the laminated body is compressed to be frictionally engaged, and the first clutch 21a is in a connected state in which power transmission is possible. When there is no supply of a hydraulic pressure to the first clutch 21a, the pressure plate is moved in the axial direction by a biasing force of a return spring. Accordingly, compression of the laminated body is released, and the first clutch 21a is in a disconnected state in which power transmission is impossible.

When a hydraulic pressure is supplied to the second clutch 21b, the laminated body is compressed to be frictionally engaged, and the second clutch 21b is in a connected state in which power transmission is possible. When there is no supply of a hydraulic pressure to the second clutch 21b, the pressure plate is moved in the axial direction by a biasing force of the return spring. Accordingly, compression of the laminated body is released, and the second clutch 21b is in a disconnected state in which power transmission is impossible.

The ECU 24 controls actuations of the twin clutch type gear change device 21M and the gear shifting device 22A based on information of various sensors, and switches gear levels (shift positions) of the transmission 26. For example, the ECU 24 sets the transmission 26 to a neutral state when the engine is stopped.

The ECU 24 leaves the transmission 26 neutral when the engine is starting.

The ECU 24 performs the following operation when an operation or the like of the mode switch is performed after the engine is started. That is, the ECU 24 actuates the gear shifting device 22A and sets the transmission 26 to a startable state (a first speed state) using a first speed gear (a starting gear, a shifting gear pair 35a) from the neutral state. For example, an engine rotation number is increased from this state, the first clutch 21a goes through the half clutch and becomes a clutch-connected state, and the vehicle is started.

In the ECU 24, when the vehicle travels, only one of the clutches 21a and 21b corresponding to the current shift position is made to a connected state, and the other is made to a disconnected state. Accordingly, power transmission of the transmission 26 is performed through one of the inner outer shafts 12a and 12b and one of the shifting gear pairs supported by the shaft. Here, the ECU 24 controls actuation of the twin clutch type gear change device 21M based on various types of vehicle information, and selects the shifting gear pair corresponding to the next shift position. The ECU 24 previously creates a state in which power transmission of the transmission 26 is possible (a state in which the corresponding dogs 38b and slots 38c are meshed with each other) using the shifting gear pair corresponding to the next shift position.

For example, when the current shift position (the gear level) is in an odd number of level (or an even number of level), the next shift position is in an even number of level (or an odd number of level). Here, the ECU 24 previously creates a state in which power transmission is possible using the shifting gear pair of any one of the even number of levels (or the odd number of levels). Here, the one clutch is in a connected state, and the other clutch is in a disconnected state. Accordingly, it can become a state in which the shifting gear pairs of both the even number of levels and the odd number of levels can simultaneously perform power transmission (a state in which the corresponding dogs 38b and slots 38c are meshed with each other).

After that, the ECU 24 sets the first clutch 21a (or the second clutch 21b) to a disconnected state and sets the second clutch 21b (or the first clutch 21a) to a connected state when it is determined that the gear shifting timing was reached. Accordingly, the transmission 26 is switched to a state in which power transmission is possible using the previously selected shifting gear pair. Accordingly, the transmission 26 can perform quick and smooth gear shifting without causing a time lag upon gear shifting or interruption of power transmission.

For example, during normal driving with a constant gear level in the transmission 26, it is possible to supply a small amount of hydraulic pressure to the clutch in the disconnected state and to operate the clutch to the side of the clutch connection by a very small amount. The small amount of hydraulic pressure is a minimum hydraulic pressure required to reduce a mechanical play of the corresponding clutch. Accordingly, shock and noise upon gear shifting of the transmission 26 can be further reduced, and smoother gear shifting can be performed.

### <Shift Fork Returning Control>

In the transmission 25 for a vehicle of the embodiment, the following operation (control) is performed when the gear level of the transmission 26 is switched from the first gear level to the next second gear level. That is, after the shift forks 33 are completely moved from a first axial position P1 corresponding to the first gear level to a second axial position P2 corresponding to the second gear level, control of returning movement of the shift forks 33 is performed such that the shift forks 33 are returned toward the first axial position P1 by a prescribed amount.

In the example in FIG. 4A to FIG. 4C, a basic operation of the shift forks 33 (and the shifter member 38) when the gear level of the transmission 26 is changed from a fifth speed to a sixth speed is shown as a reference. In this example, the shift forks 33 (and the shifter member 38 that is a driving gear 36d for a fourth speed) is at the first axial position (a non-meshed position) P1 on the left side in the drawings before the gear shifting, and is moved from the first axial position P1 to the second axial position (a meshed position) P2 on the right side in the drawings. A driving gear 36f for a sixth speed is disposed at a moving destination (the right side in the drawings) of the shifter member 38. When the shifter member 38 is moved toward the left side in the drawings, the dogs 38b provided on the left side of the shifter member 38 is inserted and fitted into the slots 38c provided on the right side of the driving gear 36f for a sixth speed. Accordingly, the shifter member 38 that is a slide gear and the driving gear 36f that is a free gear are engaged to enable torque transmission.

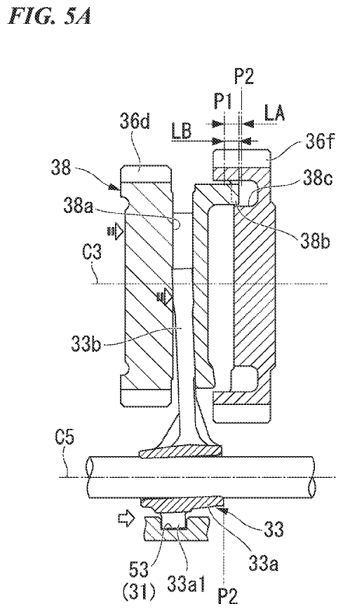

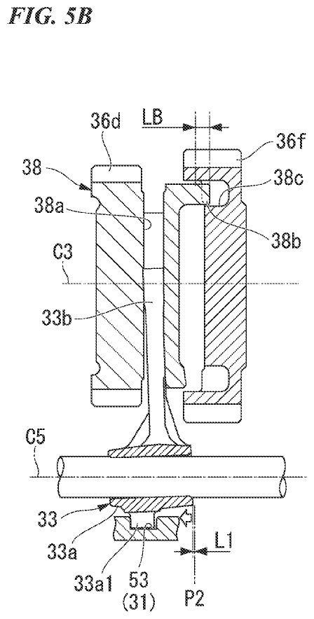

Referring to FIG. 5A and FIG. 5A, in the embodiment, after movement of the shifter member 38 toward the second axial position P2, the base end portion 33a of the shift fork 33 is returned toward the first axial position P1 by a prescribed amount L1. The returning amount (the prescribed amount) L1 is set such that meshing between the dogs 38b of the shifter member 38 and the slots 38c of the sixth speed gear can secure an effective meshing allowance (a meshing allowance required for torque transmission). For example, a prescribed amount by which the shift fork 33 (and the shifter member 38) is returned to a position before movement is set to be equal to or smaller than 10% of the entire movement amount of the shift fork 33 (and the shifter member 38). For example, when the entire movement amount (the movement amount between the first and second axial positions P1 and P2) LA of the shift fork 33 (and the shifter member 38) is 5.5 mm, the returning amount L1 is set to be equal to or smaller than 0.55 mm. In the drawings, reference sign LB indicates a movement amount from the first axial position P1 when the effective meshing allowance of the shifter member 38 is secured.

When torque transmission is performed between the shifter member 38 and a gear at a moving destination (hereinafter, referred to as a moving destination gear), a frictional force between the torque receiving surfaces of the meshing portions (the dogs 38b and the slots 38c) of the shifter member 38 and the moving destination gear is increased. The frictional force is likely to affect the meshing between the dogs 38b and the slots 38c. That is, when the frictional force is increased, the dogs 38b are difficult to be inserted into the slots 38c. For this reason, a catch is likely to occur in movement of the shifter member 38 in the axial direction, it is difficult for the shifter member 38 to move by the entire movement amount. When movement of the shifter member 38 is obstructed as the effective meshing allowance of the dogs 38b and the slots 38c cannot be secured, for example, control of restricting the gear shifting or the like is performed. When the shifter member 38 is moved such that the effective meshing allowance of the dogs 38b and the slots 38c can be secured, it becomes a state in which the gear shifting is possible.

When the dogs 38b of the shifter member 38 are not completely inserted into the slots 38c of the moving destination gear (when the shifter member 38 is not moved by the entire movement amount), a deviation in the axial direction occurs between the tip side and the base end side of the shift forks 33. That is, the tip side of the shift fork 33 stops before the second axial position P2 (on the side of the first axial position P1) corresponding to the shifter member 38. A base end side of the shift fork 33 is guided by the guide groove 53 of the shift drum 31 and moves to the second axial position P2. For this reason, the shift fork 33 becomes a state in which the base end side thereof is shifted toward the second axial position P2 than that of the tip side thereof. As a result, the shift fork 33 is inclined so that the base end side thereof is shifted toward the second axial position P2 than that of the tip side thereof. In addition, since a load is added to the based end side in a state in which movement of the tip side of the shift fork 33 is restricted, and thus, deformation of the shift fork 33 is generated. The shift fork 33 in this state is in strong contact with peripheral members. When the engine 1 is driven in the state as it is, an uneven wear may occur in the shift fork 33.

The above-mentioned event is likely to occur particularly when a torque is applied in advance to the shifting gear pair corresponding to the next shift position in the twin clutch type gear change device 21M. In other words, the event tends to occur in so-called seamless transmission in order to perform acceleration and deceleration without interruption.

While it is conceivable that the above-mentioned event can be suppressed by, for example, detecting deformation of the shift forks 33, a variation in current of the actuator 41, or the like, and controlling the driving of the actuator 41 on the basis of the detection information, but the configuration of the entire apparatus becomes complicated.

In the embodiment, even when a catch occurs in movement of the shifter member 38 in the axial direction while the configuration of the entire apparatus is simplified, in order to prevent the shift forks 33 from being continuously heavily loaded, control is performed to return movement of the shift forks 33 by a prescribed amount.

That is, the ECU 24 performs control of returning rotation of the shift drum 31 by the prescribed angle when it is detected that rotation of the shift drum 31 is terminated to perform gear shifting to the second gear level. The “prescribed angle” is a rotating angle within a range in which the gear shifting from the second gear level to the first gear level is not performed, and about 10% of the rotating angle assigned to each of the gear levels.

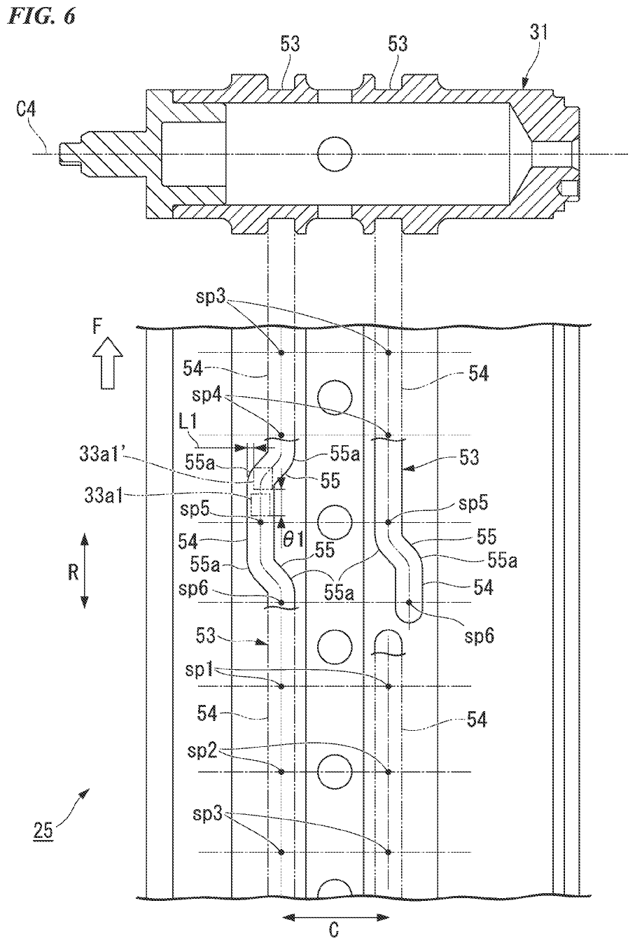

Here, the guide grooves 53 of the shift drum 31 will be described with reference to FIG. 6. The shift drum 31 of FIG. 6 has the pair of left and right guide grooves 53. While the shift drum 31 of FIG. 6 is a portion different from the shift drum 31 of FIG. 3 or the like, a major part of the guide grooves 53 is referenced. In a deployment view of a lower stage in the drawing, an arrow C in the leftward/rightward direction indicates an axial direction of the shift drum 31, and an arrow R in an upward/downward direction in the drawing indicates a circumferential direction of the shift drum 31.

The guide grooves 53 extend in the circumferential direction while being appropriately displaced in the axial direction. The guide grooves 53 define shift positions sp1 to sp6 corresponding the number of gear levels of the transmission 26 (in the embodiment, six speeds). The guide grooves 53 define the shift positions sp1 to sp6 at intervals of about 60 degrees of an axial center angle of the shift drum 31 in the order of the first speed to the sixth speed.

The engaging protrusions 33a1 protruding from the base end portion 33a of the shift forks 33 are slidably engaged with the guide grooves 53. When the shift drum 31 is rotated in this state, the engaging protrusions 33a1 are moved along the guide grooves 53 and are moved to any one of the shift positions. Accordingly, the shift forks 33 are displaced in the axial direction. The tip portion 33b of the shift fork 33 is branched in a bifurcated shape, and the tip portion 33b is engaged with the annular groove 38a of the slide gear (the shifter member 38) of the shifting gear group 35. When the shift fork 33 is moved in the axial direction, the slide gear is also moved in the axial direction according thereto and switches the gear level of the transmission 26.

The guide grooves 53 include holding sections 54 and changing parts 55.

The plurality of holding sections 54 are provided to correspond to the shift positions sp1 to sp6. Each of the holding sections 54 is provided within a range of a rotating angle of each of the shift positions in the shift drum 31. The holding sections 54 extend in the circumferential direction of the shift drum 31 while maintaining the axial positions constantly (in a linear shape in a deployment view of a lower stage in the drawing). The corresponding shift positions are provided on an intermediate section of the holding sections 54 in the lengthwise direction. The “intermediate” used in the embodiment means not only the center between both ends of the object but also an inner range between both ends of the object. The holding sections 54 hold the engaging protrusions 33a1 of the shift forks 33 at axial positions corresponding to the shift positions.

The changing parts 55 are provided between the pair of holding sections 54 adjacent to each other in the circumferential direction in the plurality of holding sections 54. The pair of holding sections 54 sandwiching the changing parts 55 change the axial positions with each other. The changing parts 55 are provided to be inclined with respect to, for example, the circumferential direction. The changing parts 55 change the axial positions toward the other side as it extends from one side toward the other side of the pair of holding sections 54 having different axial positions.

Hereinafter, the guide grooves 53 on the left side in the drawing will be described with reference to the pair of holding sections 54 corresponding to the shift positions p4 and p5, and the changing parts 55 disposed therebetween.

The holding section 54 corresponding to the shift position p5 disposed at a lower side of the changing parts 55 in the drawing is offset toward the left side in the drawing (one side in the axial direction) with respect to the holding section 54 corresponding to the shift position p4 disposed at an upper side of the changing parts 55 in the drawing. The changing part 55 is inclined to be disposed on the left side in the drawing as it goes toward the lower side in the drawing from a lower end portion of the holding section 54 disposed above in the drawing to an upper end portion of the holding section 54 disposed below in the drawing.

Both end portions 55a of the changing part 55 in the circumferential direction are curved in an arc shape to smoothly merge with the holding sections 54 connected to the end portions 55a. In the example of the changing part 55 in the drawing, the upper end portion 55a of the changing part 55 in the drawing is curved upward, and connected to smoothly merge with the holding section 54 corresponding to the shift position p4. The lower end portion 55a of the changing part 55 is curved downward, and is connected to smoothly merge with the holding section 54 corresponding to the shift position p5.

In the embodiment, for example, according to rotation of the shift drum 31 in one direction (rotation in an arrow F direction in the drawings, and hereinafter referred to as “positive rotation”), the engaging protrusions 33a1 of the shift forks 33 slide through the changing parts 55 in the guide grooves 53 and move from the axial position corresponding to the shift position p4 to the axial position corresponding to the shift position p5, and then, the following control is performed. That is, the shift drum 31 is reversed by a prescribed angle θ1, and the engaging protrusions 33a1 of the shift forks 33 are slightly raised on the outer circumferential surface of the changing part 55 at the side closer to the holding section 54 corresponding to the shift position p5 (shown by reference sign al′ in the drawings). Accordingly, the engaging protrusions 33a1 of the shift forks 33 are returned toward the side of the holding sections 54 corresponding to the shift position p4 by the prescribed amount L1.

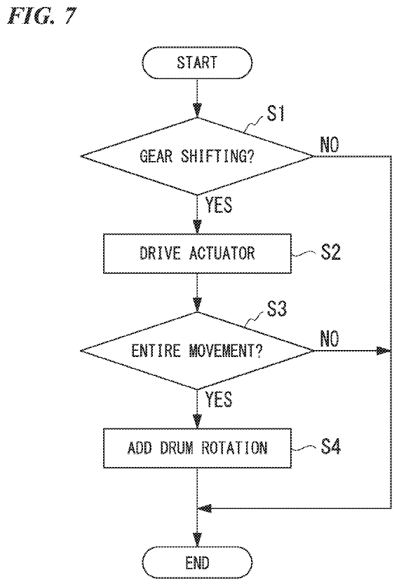

Hereinafter, processing performed by the ECU 24 to return rotation of the shift drum 31 by a prescribed angle will be described with reference to a flowchart of FIG. 7. This processing is repeatedly performed at a predetermined cycle when the power supply is ON (a main switch of the vehicle is ON) and an automatic gear shifting mode is selected.

First, it is determined whether the transmission 26 is in a state in which gear shifting is required in step S1. This determination is performed based on vehicle information such as a vehicle speed, an accelerator position, or the like. In the case of YES (gear shifting is required) in step S1, the processing advances to step S2, and the actuator 41 is driven to perform gear shifting to a previously selected gear level. In the case of NO (gear shifting is not required) in step S1, the processing is terminated once.

After the actuator 41 is driven in step S2, the processing advances to step S3, and it is determined that the shift fork 33 and the shifter member 38 are moved in the axial direction by the entire movement amount (whether the gear shifting operation is terminated). This determination is performed based on, for example, the information obtained from the rotating angle sensor 51 of the shift drum 31. In the case of YES (the entire movement) in step S3, the processing advances to step S4, and the actuator 41 is reversely driven by a predetermined amount, and the rotating angle of the shift drum 31 is returned (reverse rotation of the shift drum 31 is added). Here, as described above, the base end portion 33a side of the shift fork 33 is returned toward a position before the movement by the prescribed amount. Step S4 becomes a fork returning part of the embodiment. In the case of NO (not the entire movement) in step S3, the processing is terminated once.

In the embodiment, when the the base end portion 33a side of the shift fork 33 is moved for the extent of the entire movement, the shift drum 31 is uniformly reversed, and movement of the base end portion 33a side of the shift fork 33 is returned by a prescribed amount. The returning amount (the prescribed amount) is set to be equal to or smaller than 10% of the entire movement amount of the shift fork 33. When the returning amount is defined by a rotating angle of the shift drum 31, the rotating angle corresponding to the prescribed amount is set to be equal to or smaller than 5 degrees. The prescribed amount is set such that the effective meshing allowance between the shifter member 38 and moving destination gear can be secured even when movement of the shift fork 33 is returned by the fork returning part (control). For example, while it is possible to detect a load input state or the like of the shift fork 33 and determine whether the fork returning control of the shift fork 33 is performed on the basis of the detection information, the configuration of the entire apparatus may be complicated in this case.

When a catch occurs in movement of the shifter member 38 in the axial direction, movement of the shift fork 33 at the side of the tip portion 33b in the axial direction is restricted. Meanwhile, the base end portion 33a side of the shift fork 33 is guided to the guide groove 53 of the shift drum 31 so as to move in the axial direction. For this reason, the shift fork 33 is inclined such that the base end portion 33a side is located closer to the moving destination gear compared to the tip portion 33b side. This inclination is generated by a clearance or the like between the shift fork 33 and the fork shaft 32. In addition, a deformation in the shift fork 33 is generated by adding a load toward the base end portion 33a side in a state in which movement of the tip portion 33b of the shift fork 33 is restricted. This is because the thickness in the axial direction is restricted at the tip portion 33b side of the shift fork 33 in order to suppress a width of the transmission 26 in the axial direction.

In the embodiment, when the shifter member 38 is moved in the axial direction until the effective meshing allowance between the shifter member 38 and the moving destination gear can be secured, the shift drum 31 can be rotated to a target angle by the inclination and deformation of the shift fork 33. However, in a state in which the inclination and the deformation of the shift fork 33 occur, there is a risk that a heavy load will remain on the shift fork 33 and uneven wear or the like occurs on the shift fork 33.

On the other hand, in the embodiment, the shift drum 31 is reversed by the prescribed angle after termination of the gear shifting operation, and the base end portion 33a side of the shift fork 33 is returned by the prescribed amount before movement. Accordingly, even when a catch occurs in movement of the shifter member 38 in the axial direction and movement of the shift fork 33 is restricted, it is possible to prevent a heavy load from being continuously applied to the shift fork 33.

Further, when the shifter member 38 is not moved in the axial direction such that the effective meshing allowance between the shifter member 38 and the moving destination gear can be secured, the following event is considered. That is, it is conceivable that the engaging protrusion 33a1 of the shift fork 33 is stopped in the changing part 55 of the guide groove 53. In this case, the pivoting angle of the shift drum 31 is insufficient considerably, and the actuator 41 continues to drive. That is, the supply current to the actuator 41 is increased and a torque is continuously applied to the shift drum 31. When such an event continues for a prescribed time or more, for example, the gear shifting operation may be stopped to report abnormality to an occupant using an indicator lamp or the like, or the actuator 41 may be reversed to stop the gear shifting.

As described above, the transmission 25 for a vehicle of the embodiment includes the transmission 26 configured to support the shifting gear group 35 having the plurality of gear levels on the main shaft 12 and the counter shaft 13 and configured to move the shifter member 38 in the axial direction of the main shaft 12 and the counter shaft 13 for switching the gear level, the shift forks 33 configured to engage the tip portions 33b of the shift fork 33 with the shifter member 38 and move the shifter member 38 in the axial direction, the shift drum 31 formed in the cylindrical shape having the central axis C4 parallel to the axial direction, having the guide grooves 53 formed on the outer circumferential section of the shift drum 31 and guides movement of the shift forks 33 in the axial direction, and configured to move the engaging protrusions 33a1 along the guide grooves 53 and change the axial positions of the shift forks 33 for switching the gear level of the transmission 26 by rotating around the central axis C4 while the engaging protrusions 33a1 formed on the base end portion 33a of the shift forks 33 are engaged with the guide grooves 53, the actuator 41 configured to pivot the shift drum 31, and the ECU 24 configured to control driving of the actuator 41, and the ECU 24 rotates the shift drum 31 in the first direction through driving of the actuator 41, changes the axial positions of the engaging protrusions 33a1 of the shift forks 33 from the first axial position P1 corresponding to the first gear level before gear shifting to the second axial position P2 corresponding to the second gear level after the gear shifting, rotates the shift drum 31 by the prescribed angle θ1 in the second direction opposite to the first direction within the range in which the second gear level is maintained (the gear shifting is not performed to another gear level) through driving of the actuator 41, and returns the axial positions of the engaging protrusions 33a1 of the shift forks 33 to a side closer to the first axial position P1 than the second axial position P2 by the prescribed amount L1.

According to this configuration, after the actuator 41 is positively rotated and the gear level of the transmission 26 is switched, the actuator 41 is reversed by the prescribed angle while the second gear level is maintained. Accordingly, the base end sides of the shift forks 33 are returned toward the first axial position P1 before gear shifting by the prescribed amount. For this reason, an influence on a frictional resistance generated in the concavo-convex fitting section (the dogs 38b and the slots 38c) between the shifter member 38 and the counter member that is the moving destination thereof is minimized That is, even when movement of the tip side of the shifter member 38 in the axial direction stops before the target position after gear shifting, the shift fork 33 is prevented from being continuously heavily loaded. When the insufficient amount in the movement of the shifter member 38 in the axial direction is small, the effective fitting allowance (engagement allowance) required for torque transmission between the shifter member 38 and the moving destination member is secured. In addition, the shift drum 31 can also be rotated to the target angle extent while having the inclination or deformation of the shift fork 33. Meanwhile, while the inclination or deformation is generated in the shift fork 33, a state in which a heavy load is continuously applied to the shift fork 33 is maintained, and damage such as an uneven wear or the like is likely to occur on the shift forks 33.

On the other hand, according to this configuration of the embodiment, the following effects are exhibited while using the actuator 41 as the system configured to drive the shift drum 31 directly. That is, even when a catch occurs in movement of the shifter member 38 in the axial direction, it is possible to prevent the shift fork 33 from becoming a state in which an excessive load continues to be input.

While such effects can be exhibited by, for example, detecting the load input state or the like of the shift forks 33 and controlling driving of the actuator 41, the configuration of the entire apparatus may be complicated. Therefore, according to this configuration of the embodiment, even when a catch occurs in movement of the shifter member 38 in the axial direction while the configuration of the entire apparatus is simplified, it is possible to prevent the shift fork 33 from being continuously heavily loaded.

In addition, in the transmission 25 for a vehicle, the prescribed angle θ1 at which the actuator 41 returns rotation of the shift drum 31 is equal to or smaller than 5 degrees.

According to this configuration, for example, when the number of gear levels of the transmission 26 is generally six speeds, the pivoting angle of the shift drum 31 for each speed is 50 to 60 degrees. The shift fork 33 can be prevented from moving excessively to the return side and the engagement allowance between the shifter member 38 and the moving destination member can be secured by minimizing the returning groove of the shift drum 31 to 10% or less therein.

Further, in the transmission 25 for a vehicle, the actuator 41 includes the electric motor 42 configured to generate a rotating driving force, the central axis C4 of the shift drum 31 and the driving axis C6 of the motor are parallel to each other, and the transmission mechanism 44 configured to transmit the driving force of the electric motor 42 to the shift drum 31 is provided on one end side of the shift drum 31 and the electric motor 42 in the axial direction.

According to this configuration, since the shift drum 31 and the electric motor 42 are disposed on the same side of the transmission mechanism 44 in the axial direction, the change mechanism 22 including the shift drum 31 and the actuator 41 including the electric motor 42 can be disposed in a compact combination.

Further, in the transmission 25 for a vehicle, the rotating angle sensor 51 configured to detect a rotating angle of the shift drum 31 is provided on the other side of the shift drum 31 in the axial direction.

According to this configuration, since the transmission mechanism 44 and the rotating angle sensor 51 are arranged and disposed on both sides of the shift drum 31 in the axial direction, surroundings of the shift drum 31 can be provided compactly.

### Second Embodiment

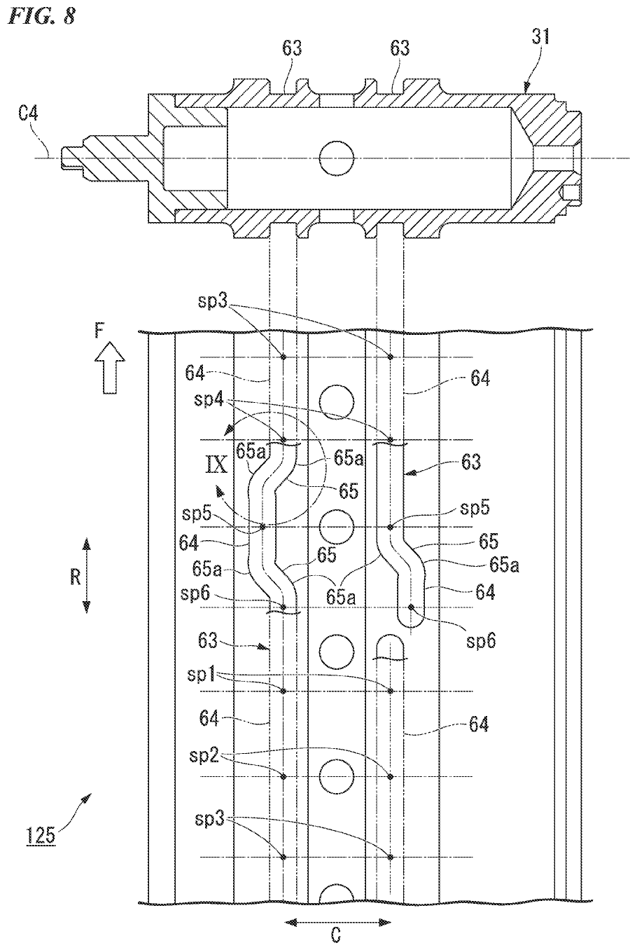

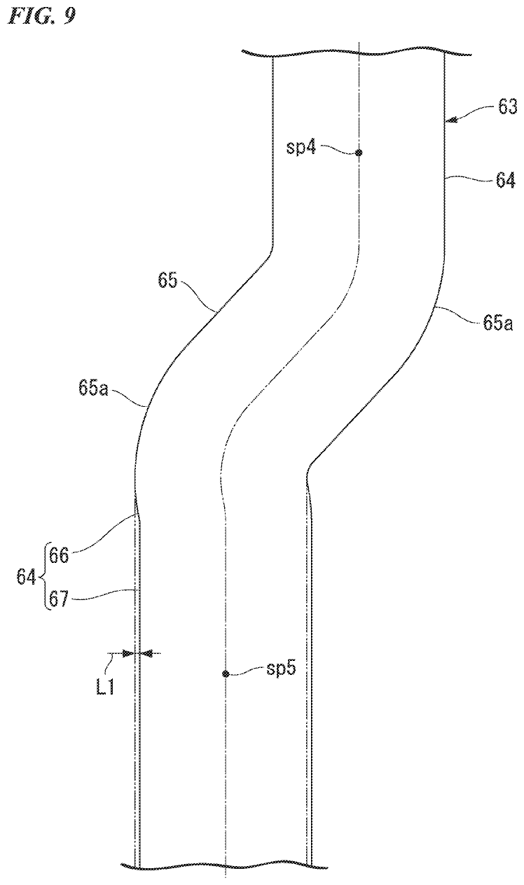

Next, a second embodiment of the present invention will be described with reference to FIG. 8 and FIG. 9 while FIG. 1 to FIG. 5B are incorporated.

A transmission 125 for a vehicle of the second embodiment is particularly distinguished from the transmission 25 for a vehicle of the first embodiment in that a structure (a returning part) serving as a fork returning part is provided in a guide groove 63 of the shift drum 31. In addition, the same components as the embodiment are designated by the same reference signs and detailed description thereof will be omitted.

As shown in FIG. 8, the guide groove 63 of the second embodiment includes a holding section 64 and a changing part 65.

Referring also to FIG. 9, the holding section 64 of the second embodiment is particularly distinguished from the holding section 54 of the first embodiment in that a returning changing part 66 and a returning holding section 67 are provided as the returning part configured to return the axial position of the engaging protrusion 33a1 of the shift fork 33 by the prescribed amount before movement.

The plurality of holding sections 64 are provided to correspond to the shift positions sp1 to sp6. Each of the holding sections 64 are provided within a rotating angle corresponding to each of the shift positions in the shift drum 31. Each of the holding sections 64 includes the returning holding section 67 extending in the circumferential direction of the shift drum 31 at a constant axial position (extending in a linear shape when seen in a deployment view of a lower stage in the drawing), and the returning changing part 66 provided on an end portion of the returning holding section 67 in the lengthwise direction. The corresponding shift position is provided on an intermediate section in the lengthwise direction of the returning holding section 67 of each of the holding sections 64.

The changing part 65 is provided between the pair of holding sections 64 adjacent to each other in the circumferential direction of the plurality of holding sections 64. The axial positions of the pair of holding sections 64 sandwiching the changing part 65 are changed with respect to each other. For example, the changing part 65 is provided to be inclined with respect to the circumferential direction. The changing part 65 changes the axial position toward the other side as it extends from one side toward the other side of the pair of holding sections 64 having the different axial positions

Hereinafter, the guide groove 63 on the left side in the drawing will be described with reference to the pair of holding sections 64 corresponding to the shift positions p4 and p5 and the changing part 65 disposed therebetween.

The holding section 64 corresponding to the shift position p5 disposed at the lower side of the changing part 65 in the drawing is offset with respect to the holding section 64 corresponding to the shift position p4 disposed at the upper side of the changing part 65 in the drawing on the left side in the drawing (one side in the axial direction). The changing part 65 is inclined to be disposed on a leftward side in the drawing as it goes downward in the drawing from the lower end portion of the holding section 64 disposed above in the drawing to the upper end portion of the holding section 64 disposed below in the drawing.

Both end portions 65a of the changing part 65 in the circumferential direction are curved in an arc shape to smoothly merge with the holding section 64 connected to each of the end portions 65a. In the example of the changing part 65 in the drawing, the upper end portion 65a of the changing part 65 in the drawing is curved upward, and is continuous to smoothly merge with the holding section 64 corresponding to the shift position p4. The lower end portion 65a of the changing part 65 in the drawing is curved downward, and is continuous to smoothly merge with the holding section 64 corresponding to the shift position p5.

The changing part 65 moves the engaging protrusion 33a1 of the shift fork 33 from the axial position corresponding to the shift position p4 (the first axial position P1 corresponding to the first gear level before gear shifting) to the axial position corresponding to the shift position p5 (the second axial position P2 corresponding to the second gear level after gear shifting) according to rotation of the shift drum 31 in one direction (an arrow F direction in the drawing).

The returning changing parts 66 of the neighboring holding sections 64 are continuous with the end portions 65a of the changing part 65. The returning changing part 66 is curved to be continuous with the end portions 65a of the changing part 65 and is folded back toward the first axial position P1, and the axial position of the engaging protrusion 33a1 of the shift fork 33 is returned from the second axial position P2 toward the first axial position P1 by the prescribed amount. The returning holding section 67 is continuous with a side of the returning changing part 66 upstream from the shift drum 31 in the rotation direction. The returning holding section 67 extends in a linear shape in the circumferential direction of the shift drum 31 at the constant axial position.

In the embodiment, for example, according to the rotation of the shift drum 31 in one direction (the rotation of the arrow direction in the drawing), the engaging protrusion 33a1 of the shift fork 33 slides through the changing part 65 in the guide groove 63 and moves from the axial position corresponding to the shift position p4 to the axial position corresponding to the shift position p5, and then, the following operation is performed. That is, the engaging protrusion 33a1 of the shift fork 33 reaches the returning changing part 66 continuous with a side of the guide groove 63 upstream from the changing part 65, guided to the returning changing part 66 and returns the axial position toward the shift position p4 by the prescribed amount. The “prescribed amount” is a returning amount that does not return to the gear level before gear shifting (within a range in which gear shifting from the second gear level after gear shifting to the first gear level before gear shifting is not performed), and is equal to or smaller than 10% of the movement amount when the gear shifting is performed from the first gear level to the second gear level.

Further, in the drawing, while the returning changing part 66 and the returning holding section 67 have only some of the holding sections 64, an aspect in which all the holding sections 64 have the returning changing part 66 and the returning holding section 67 (an aspect in which the axial position is returned) may be provided.

As described above, the transmission 125 for a vehicle according to the second embodiment includes the transmission 26 configured to support the shifting gear group 35 having the plurality of gear levels on the main shaft 12 and the counter shaft 13 and moving the shifter member 38 in the axial direction of the main shaft 12 and the counter shaft 13 for switching the gear level, the shift forks 33 configured to engage the tip portions 33b of the shift fork 33 with the shifter member 38 and move the shifter member 38 in the axial direction, and the shift drum 31 formed in the cylindrical shape having the central axis C4 parallel to the axial direction, having the guide groove 63 formed in the outer circumferential section of the shift drum and guides movement of the shift forks 33 in the axial direction, configured to engage the engaging protrusions 33a1 provided on the base end portion 33a of the shift fork 33 with the guide groove 63, configured to move the engaging protrusions 33a1 along the guide groove 63 by being rotated around the central axis C4, and configured to change the axial position of the shift forks 33 to switch the gear level of the transmission 26, and the guide groove 63 includes the changing part 65 configured to change the axial positions of the engaging protrusions 33a1 of the shift forks 33 from the first axial position P1 corresponding to the first gear level before gear shifting to the second axial position P2 corresponding to the second gear level after gear shifting according to rotation of the shift drum 31, and the returning part (the returning changing part 66 and the returning holding section 67) continuous with a side of the changing part 65 upstream from the shift drum 31 in the rotation direction and configured to change the axial positions of the engaging protrusion 33a1 of the shift forks 33 to a side closer to the first axial position P1 than the second axial position P2 by the prescribed amount L1 within the range in which the second gear level is maintained.

According to this configuration, according to the pattern of the cam groove of the shift drum 31, the base end sides of the shift forks 33 moved to the second axial position P2 after gear shifting is returned toward the first axial position P1 before gear shifting by the prescribed amount. That is, the base end sides of the shift forks 33 moved to the second axial position P2 by the changing part 65 are returned toward the first axial position P1 by the returning part by the prescribed amount. For this reason, an influence on a frictional resistance generated in the concavo-convex fitting section between the shifter member 38 and the counter member that is the moving destination thereof is minimized That is, even when movement of the tip side of the shifter member 38 in the axial direction stops before the target position after gear shifting, the shift forks 33 are prevented from being continuously heavily loaded. When the insufficient amount in the movement of the shifter member 38 in the axial direction is small, the effective fitting allowance (engagement allowance) required for torque transmission between the shifter member 38 and the moving destination member is secured. In addition, according to the inclination or deformation of the shift forks 33, the shift drum 31 can also be rotated by the target angle extent. Meanwhile, when the inclination or deformation occurs in the shift forks 33, the shift forks 33 are being continuously heavily loaded. Accordingly, damage such as an uneven wear or the like are likely to occur in the shift forks 33.

On the other hand, according to the configuration of the second embodiment, for example, in the configuration in which the shift drum 31 is directly driven by the actuator 41, even when a catch occurs in movement of the shifter member 38 in the axial direction, it is possible to prevent an excessive load from being continuously input to the shift forks 33.

Such effects can be exhibited by, for example, detecting the load input state or the like of the shift forks 33 and controlling driving of the actuator 41, but the configuration of the entire apparatus may be complicated. Accordingly, according to the configuration of the second embodiment, even when the catch occurs in movement of the shifter member 38 in the axial direction while the configuration of the entire apparatus is simplified, the shift forks 33 can be prevented from being continuously heavily loaded.

Further, the control shown in FIG. 7 can also be performed in the second embodiment.

That is, when it is determine that the actuator 41 is driven in step S2 in FIG. 7 and the shift forks 33 and the shifter member 38 are moved in the axial direction by the entire movement amount in step S3 (determination as YES), the base end portion 33a of the shift fork 33 is in a state in which the base end portion 33a has climbed the changing part 65 to the end.

In the first embodiment, when it is determined as YES in step S3, reverse rotation of the actuator 41 and the shift drum 31 is added in step S4, and the base end portion 33a side of the shift fork 33 is returned by the prescribed amount.

In the second embodiment, since the returning part (the returning changing part 66 and the returning holding section 67) configured to return the axial position of the engaging protrusion 33a1 of the shift fork 33 by the prescribed amount L1 is provided upstream from the changing part 65 in the rotation direction, when it is determined as YES in step S3, positive rotation of the actuator 41 and the shift drum 31 is added in step S4, and the base end portion 33a side of the shift fork 33 is returned by the prescribed amount.

In the transmission 125 for a vehicle, the prescribed amount L1 by which the returning part returns the shift fork 33 is equal to or smaller than 10% of the movement amount from the first axial position P1 to the second axial position P2.

According to this configuration, excessive movement of the shift forks 33 to the returning side can be suppressed and engagement allowance between the shifter member 38 and the moving destination member can be secured by minimizing the returning amount of the shift forks 33 to be equal to or smaller than 10% of the entire movement amount of the shift forks 33.

Further, the present invention is not limited to the example, and for example, the actuator is not limited to an electric motor configured to generate rotating power as a driving source and may include a solenoid or a hydraulic instrument configured to generate reciprocal movement.

The engine is not limited to include a twin clutch and may include a single clutch. The transmission may slide the shifter member separated from the gear to switch the gear level, and the number of gear levels may be less than six speeds or seven speeds or more.

The configuration of the guide groove of the shift drum of the second embodiment is not limited to the automatic gear change device configured to drive the shift drum using the actuator and may be applied to a manual gear change device having no actuator. The saddle riding vehicle to which the vehicle transmission of the present invention is applied is not limited to a motorcycle, and may be a three-wheeled or four-wheeled saddle riding vehicle or a scooter-type vehicle having a floor-shaped footrest section. Then, the configuration according to the example is an example of the present invention, and various modifications may be made without departing from the scope of the present invention.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A vehicle transmission comprising:
a gear change device configured to support a shifting gear group having a plurality of gear levels on a gear change device shaft and configured to move a shifter member in an axial direction of the gear change device shaft for switching the gear levels;
a shift fork configured to engage a tip portion of the shirt fork with the shifter member and move the shifter member in the axial direction;
a shift drum formed in a cylindrical shape having a central axis parallel to the axial direction, having a guide groove formed in an outer circumferential section of the shift drum and guides movement of the shift fork in the axial direction, configured to engage an engaging section provided on a base end portion of the shift fork with the guide groove, configured to move the engaging section along the guide groove by being rotated around the central axis, and configured to change an axial position of the shift fork for switching the gear levels of the gear change device; and
an actuator configured to pivot the shift drum,
wherein the transmission changes the axial position of the engaging section of the shift fork from a first axial position corresponding to a first gear level before gear shifting to a second axial position corresponding to a second gear level after gear shifting, and
within a range in which the second gear level is maintained, the shift drum is rotated and the axial position of the engaging section of the shift fork is returned to a side closer to the first axial position than the second axial position by a prescribed amount.

2. The vehicle transmission according to claim 1, wherein a control part configured to control driving of the actuator is provided,
the control part rotates the shift drum in a first direction by driving of the actuator and changes the axial position of the engaging section of the shift fork from a first axial position corresponding to a first gear level before gear shifting to a second axial position corresponding to a second gear level after gear shifting, and
within a range in which the second gear level is maintained by driving of the actuator, the control part rotates the shift drum in a second direction opposite to the first direction by a prescribed angle and returns the axial position of the engaging section of the shift fork to a side closer to the first axial position than the second axial position by a prescribed amount.

3. The vehicle transmission according to claim 1, wherein the guide groove comprises:
a changing part configured to change the axial position of the engaging section of the shift fork from a first axial position corresponding to a first gear level before gear shifting to a second axial position corresponding to a second gear level after gear shifting by rotation of the shift drum; and
a returning part continuous with a side of the changing part upstream from the shift drum in a rotation direction and configured to change the axial position of the engaging section of the shift fork to a side closer to the first axial position than the second axial position by a prescribed amount within a range in which the second gear level is maintained.

4. The vehicle transmission according to claim 2, wherein a prescribed angle by which the actuator returns rotation of the shift drum is equal to or smaller than 5 degrees.

5. The vehicle transmission according to claim 3, wherein a prescribed amount by which the returning part returns the shift fork is equal to or smaller than 10% of the movement amount from the first axial position to the second axial position.

6. The vehicle transmission according to claim 2, wherein the actuator comprises a motor configured to generate a rotating driving force,
a central axis of the shift drum and a driving axis of the motor are parallel to each other, and
a transmission mechanism configured to transmit a driving force of the motor to the shift drum is provided at one end side of the shift drum and the motor in the axial direction.

7. The vehicle transmission according to claim 6, wherein a rotating angle sensor configured to detect a rotating angle of the shift drum is provided at the other end side of the shift drum in the axial direction.
